(19) United States
(12) Patent Application Publication
(10) Pub. No.: US 2026/0310976 A1
(43) Pub. Date: Oct. 8, 2026

(54) DATA PROCESSING METHOD AND APPARATUS, ELECTRONIC DEVICE AND STORAGE MEDIUM

(71) Applicant: SHANGHAI BIREN TECHNOLOGY CO., LTD., Shanghai (CN)

(72) Inventors: Zheng CAO, Shanghai (CN); Li LIU, Shanghai (CN); Zhen CHENG, Shanghai (CN); Shan TANG, Shanghai (CN)

(73) Assignee: SHANGHAI BIREN TECHNOLOGY CO., LTD., Shanghai (CN)

(21) Appl. No.: 19/480,358

(22) PCT Filed: Mar. 26, 2024
(86) PCT No.: PCT/CN2024/083793

§ 371 Date: Oct. 30, 2025

(30) Foreign Application Priority Data
May 10, 2023 (CN) 202310524156.9

(51) Int. Cl. G06N 3/09; G06N 3/045

(52) U.S. Cl. CPC G06N 3/09; G06N 3/045

(57) ABSTRACT

Disclosed are a data processing method and apparatus, a storage medium, and an electronic device. A neural network is used to perform an inference operation on data to be processed, comprising successively performing M rounds of inference on the data to be processed, wherein the process of the i-th round of inference comprises: at a first stage, performing inference on N2 input data elements, and at a second stage, performing inference on N1 input data elements, the N1 input data elements, which belong to the same batch of input data, being a subset of the N2 input data elements; the inference process of the (i+1)-th round of inference comprises: for N2-N1 input data elements for which the inference is incomplete in the i-th round of inference but for which the output tokens have been acquired, performing inference on the N2-N1 input data elements while taking into account the output tokens.

This application claims the priority benefit of China application serial no. 202310524156.9, filed on May 10, 2023. The entirety of the above-mentioned patent application is hereby incorporated by reference herein and made a part of this specification.

### TECHNICAL FIELD

Embodiments of the present disclosure relate to a data processing method, a data processing apparatus, an electronic device, and a non-transitory computer-readable storage medium.

### DESCRIPTION OF RELATED ART

Artificial neural networks (ANNs), also referred to as neural networks, are algorithmic mathematical models that mimic the behavioral characteristics of animal neural networks to perform distributed and parallel information processing. These networks achieve information processing by adjusting the interconnections among a large number of internal nodes, depending on complexity of the system. Regardless of the type of artificial neural networks, they share common characteristics such as large-scale parallel processing, distributed storage, flexible topology, high redundancy, and nonlinear operations. These features endow ANNs with capabilities in computational speed, associative memory, adaptability, fault tolerance, and self-organization. These attributes form the technological foundation for simulating intelligent activities through artificial neural networks, which have found significant applications across various technical fields. For instance, artificial neural networks can be employed in data compression, data processing, video encoding, and signal processing.

### SUMMARY OF DISCLOSURE

At least one embodiment of the present disclosure provides a data processing method, including: performing an inference operation on data to be processed through a neural network, the inference operation including: using the neural network to perform M rounds of inference successively on the data to be processed, wherein the data to be processed includes multiple batches of input data, each batch of the input data includes N1 input data elements, and the entire inference process is completed on only one batch of the input data in each round of inference, and M and N1 are positive integers greater than 1. The M rounds of inference include an i-th round of inference and an (i+1)-th round of inference executed successively in order, i is a positive integer and less than M, wherein an inference process of the i-th round of inference includes: at a first stage of the inference process of the i-th round of inference, performing inference on N2 input data elements, at a second stage of the inference process of the i-th round of inference, performing inference on N1 input data elements to complete the entire inference process on the N1 input data elements belonging to the same batch of input data; wherein the first stage is earlier than the second stage, N2 is greater than N1, and the N1 input data elements belonging to the same batch of the input data are a subset of the N2 input data elements. An inference process of the (i+1)-th round of inference includes: for N2-N1 input data elements for which the inference is incomplete in the i-th round of inference but for which output tokens have been acquired through the inference, performing inference on the N2-N1 input data elements while taking into account the output tokens.

For example, in a data processing method provided by at least one embodiment of the present disclosure, the neural network includes a first sub-network and a second sub-network. The first sub-network is configured to receive the input data elements and extract semantic features corresponding to the input data elements in conjunction with a self-attention mechanism, wherein the semantic features include initial key tensors and initial value tensors. The second sub-network is configured to predict output token sequences corresponding to the input data elements one by one based on the semantic features in conjunction with an autoregressive mechanism. In the process of predicting the output token sequences corresponding to the input data elements one by one in conjunction with the autoregressive mechanism, the initial key tensors and the initial value tensors are continuously updated according to already predicted output tokens to obtain updated key tensors and updated value tensors, and lengths of the updated key tensors and the updated value tensors are in a positive proportional relationship with the number of output tokens corresponding to the input data elements that have been predicted.

For example, in a data processing method provided by at least one embodiment of the present disclosure, N1 is determined by the number of tokens of a longest output token sequence supported by the neural network, a maximum length of input data elements supported by the neural network, and a size of a storage space used to store the updated key tensors and the updated value tensors.

For example, in a data processing method provided by at least one embodiment of the present disclosure, at the first stage of the inference process of the i-th round of inference, performing inference on the N2 input data elements includes: determining X batches of input data as the N2 input data elements, wherein the X batches of input data include a first batch of input data, the first batch of input data includes the N1 input data elements for which the entire inference process is complete in the i-th round of inference, X is a positive integer greater than 1; and performing inference on the X batches of input data simultaneously in units of batches.

For example, in a data processing method provided by at least one embodiment of the present disclosure, determining the X batches of input data as the N2 input data elements includes: in response to i being equal to 1, determining X batches of input data for which the inference is entirely not performed as the X batches of input data; in response to i being greater than 1: determining X−1 batches of input data for which the inference is incomplete in the (i−1)-th round of inference, together with one batch of input data for which the inference is entirely not performed, as the X batches of input data, wherein the first batch of input data is determined from the X−1 batches of input data for which the inference is incomplete in the (i−1)-th round of inference.

For example, in a data processing method provided by at least one embodiment of the present disclosure, the X−1 batches of input data other than the first batch of input data among the X batches of input data have respective corresponding inference suspension thresholds. Performing inference on the X batches of input data simultaneously in units of batches includes: performing inference on the X batches of input data simultaneously, wherein for any batch of input data among the X−1 batches of input data, when the number of output tokens that have been acquired through the inference for the any batch of input data reaches the corresponding inference suspension threshold, suspending the inference on the any batch of input data.

For example, in a data processing method provided by at least one embodiment of the present disclosure, in response to X=2, the inference suspension threshold is calculated as (L−2P)/3, wherein P is a maximum length of input text corresponding to one batch of input data supported by the neural network, L is a sum of the number of tokens of the longest output token sequence supported by the neural network and P, and “/” represents division.

For example, in a data processing method provided by at least one embodiment of the present disclosure, when the number of output tokens that have been acquired through the inference for the any batch of input data reaches the corresponding inference suspension threshold, suspending the inference on the any batch of input data includes: suspending the inference on the any batch of input data; storing the output tokens that have been acquired through the inference for the any batch of input data; clearing the updated key tensors and the updated value tensors generated by the any batch of input data in the i-th round of inference.

For example, in a data processing method provided by at least one embodiment of the present disclosure, storing the output tokens that have been acquired through the inference for the any batch of input data includes: converting each output token among the output tokens that have been acquired through the inference for the any batch of input data to a corresponding token index; storing the token indices respectively corresponding to the output tokens that have been acquired through the inference for the any batch of input data.

For example, in a data processing method provided by at least one embodiment of the present disclosure, performing inference on the X batches of input data simultaneously includes: in response to i being greater than 1, for the other X−1 batches of input data among the X batches of input data except the one batch of input data for which the inference is entirely not performed: for the N2-N1 input data elements for which the inference is incomplete in the i-th round of inference but for which the output tokens have been acquired through the inference, performing inference on the other X−1 batches of input data while taking into account the output tokens.

For example, in a data processing method provided by at least one embodiment of the present disclosure, at the second stage of the inference process of the i-th round of inference, performing inference on the N1 input data elements to complete the entire inference process on the N1 input data elements belonging to the same batch of input data includes: performing inference continuously on the first batch of input data until completing the inference on all input data elements in the first batch of input data, wherein the first batch of input data includes the N1 input data elements for which the entire inference process is complete in the i-th round of inference.

For example, in a data processing method provided by at least one embodiment of the present disclosure, for the N2-N1 input data elements for which the inference is incomplete in the i-th round of inference but for which the output tokens have been acquired through the inference, performing inference on the N2-N1 input data elements while taking into account the output tokens includes: obtaining the output tokens that have been acquired through the inference for the N2-N1 input data elements in the i-th round of inference, wherein the output tokens that have been acquired through the inference for the N2-N1 input data elements are stored in a storage space in the form of token indices; performing inference on the N2-N1 input data elements in units of batches, wherein for each input data element among the N2-N1 input data elements, inputting the obtained output tokens that have been acquired through the inference for the input data elements and the input data elements together into the neural network for inference.

For example, in a data processing method provided by at least one embodiment of the present disclosure, inputting the obtained output tokens that have been acquired through the inference for the input data elements and the input data elements together into the neural network for inference includes: concatenating token indices corresponding to the output tokens that have been acquired through the inference for the input data elements and token indices corresponding to the input data element, and inputting the concatenation result into the neural network for inference.

For example, in a data processing method provided by at least one embodiment of the present disclosure, the neural network includes a first sub-network for performing prompt inference and a second sub-network for performing token inference. While performing the prompt inference on the N2-N1 input data elements through the first sub-network, the prompt inference is performed on one batch of input data for which the inference is entirely not performed through the first sub-network. After the prompt inference is complete for both the N2-N1 input data elements and the one batch of input data for which the inference is entirely not performed, the token inference is simultaneously initiated on the N2-N1 input data elements and the one batch of input data for which the inference is entirely not performed through the second sub-network.

For example, in a data processing method provided by at least one embodiment of the present disclosure, N2 is an integer multiple of N1.

At least one embodiment of the present disclosure provides a data processing apparatus, including: an inference unit, configured to perform an inference operation on data to be processed through a neural network, wherein the inference operation includes: using the neural network to perform M rounds of inference successively on the data to be processed, wherein the data to be processed includes multiple batches of input data, each batch of the input data includes N1 input data elements, and the entire inference process is completed on only one batch of the input data in each round of inference, and M and N1 are positive integers greater than 1. The M rounds of inference include an i-th round of inference and an (i+1)-th round of inference executed successively in order, i is a positive integer and less than M, wherein the inference process of the i-th round of inference includes: at a first stage of the inference process of the i-th round of inference, performing inference on N2 input data elements, at a second stage of the inference process of the i-th round of inference, performing inference on N1 input data elements to complete the entire inference process on the N1 input data elements belonging to the same batch of input data; wherein the first stage is earlier than the second stage, N2 is greater than N1, and the N1 input data elements belonging to the same batch of the input data are a subset of the N2 input data elements. The inference process of the (i+1)-th round of inference includes: for N2-N1 input data elements for which the inference is incomplete in the i-th round of inference but for which output tokens have been acquired through the inference, performing inference on the N2-N1 input data elements while taking into account the output tokens.

For example, a data processing apparatus provided by at least one embodiment of the present disclosure further includes a storage unit. The storage unit is configured to store weight parameters of the neural network and updated key tensors and updated value tensors generated during the inference operation.

At least one embodiment of the present disclosure provides an electronic device, including: a memory, which non-transiently stores computer-executable instructions; a processor, configured to run the computer-executable instructions, wherein when the computer-executable instructions are run by the processor, the data processing method according to any embodiment of the present disclosure is implemented.

At least one embodiment of the present disclosure provides a non-transitory computer-readable storage medium, wherein the non-transitory computer-readable storage medium stores computer-executable instructions, and when the computer-executable instructions are executed by a processor, the data processing method according to any embodiment of the present disclosure is implemented.

### BRIEF DESCRIPTION OF THE DRAWINGS

In order to more clearly illustrate the technical solutions of the embodiments of the present disclosure, the drawings of the embodiments will be briefly introduced below. Clearly, the drawings described below only relate to some embodiments of the present disclosure, and are not limitations to the present disclosure.

FIG. 1 is a schematic structural view of a neural network provided by at least one embodiment of the present disclosure.

FIG. 2 is a flowchart of an inference operation provided by an embodiment of the present disclosure.

FIG. 3 is a schematic view of an execution process of a data processing method provided by an embodiment of the present disclosure.

FIG. 4 is a schematic block diagram of a data processing apparatus provided by at least one embodiment of the present disclosure.

FIG. 5 is a schematic block diagram of an electronic device provided by an embodiment of the present disclosure.

FIG. 6 is a schematic view of a non-transitory computer-readable storage medium provided by at least one embodiment of the present disclosure.

FIG. 7 is a schematic view of a hardware environment provided by at least one embodiment of the present disclosure.

### DESCRIPTION OF THE EMBODIMENTS

In order to make the objectives, technical solutions and advantages of the embodiments of the present disclosure clearer, the technical solutions of the embodiments of the present disclosure will be described clearly and completely below in combination with the accompanying drawings of the embodiments of the present disclosure. Clearly, the described embodiments are part of the embodiments of the present disclosure, rather than all of the embodiments. Based on the described embodiments of the present disclosure, all other embodiments obtained by those of ordinary skill in the art without creative labor fall within the scope to be protected by the present disclosure.

Unless otherwise defined, technical terms or scientific terms used in the present disclosure should have the usual meanings understood by those with general skills in the field to which the present disclosure belongs. “First”, “second” and similar words used in the present disclosure do not indicate any order, quantity or importance, but are only used to distinguish different components. Similar words such as “include” or “comprise” mean that the elements or objects appearing before the word cover the elements or objects listed after the word and their equivalents, without excluding other elements or objects. Similar words such as “connect” or “connected” are not limited to physical or mechanical connections, but may include electrical connections, whether direct or indirect. “Up”, “down”, “left”, “right”, etc. are only used to indicate relative positional relationships. When the absolute position of the described object changes, the relative positional relationship may also change accordingly. In order to keep the following description of the embodiments of the present disclosure clear and concise, the present disclosure omits detailed descriptions of some known functions and known components.

A transformer model is a classic neural network-based text processing model, which has given rise to important models such as BERT (Bidirectional Encoder Representation from Transformers) and GPT (Generative Pre-trained Transformer) that have greatly advanced the development of the NLP (Natural Language Processing) field.

A self-attention mechanism is a very important part of the transformer and models evolved based on the transformer. The self-attention mechanism is a special structure embedded in machine learning models, used to automatically learn and calculate the contribution of input data to output data. Using the self-attention mechanism can connect information at different positions in the input sequence and integrate the model's understanding of relevant words used to explain the context of a word. Currently, the self-attention mechanism has become one of the most widely applied “components” in the field of deep learning, especially in the field of natural language processing.

The self-attention mechanism mainly uses three intermediate cache tensors: query tensor, key tensor and value tensor. Among the three intermediate cache tensors, the query tensor of a token (a linguistic unit in natural language processing, which may refer to a word or part of a word) is used to multiply with the key tensors of other tokens to obtain the attention scores of other tokens relative to this token; the key tensor is like a tag for each token in the sequence, and used to match objects when searching for relevant tokens; the value tensor is the real representation of the token. After calculating the attention scores, the value tensor is used to perform weighted summation to obtain a tensor that can represent the context of the current position, and this tensor is used to predict the output.

GPT and other models also use autoregressive mechanisms for inference or training, which use deep learning to generate human-like text. After training, the model may predict what the next token is based on previously predicted tokens. For example, the autoregressive mechanism may include that the token currently output by the model may be added after the previously generated token sequence as the new input for the next step of the model, or the token currently output by the model may directly serve as the new input for the next step of the model to predict the next token based on the new input. During the inference process, the model combines the autoregressive mechanism to predict backward one by one, sequentially outputting predicted tokens, and finally obtaining the output token sequence corresponding to the input.

In deep learning, inference may be performed on data in units of batches to find the optimal balance between memory efficiency and memory capacity. For example, the data to be processed for inference may be divided into multiple batches, the size of each batch is called batch size, and each batch of input data includes a batch size number of input data elements. Each input data element may be the minimum unit processed by the neural network, for example, one input data element may be in the form of a sentence input by a user. The data in one batch is used to calculate one gradient descent, and the loss function required for each parameter update in deep learning is not obtained from one input data element, but weighted from a batch size number of input data elements. For example, if the batch size is 32, it means that inference may be performed on 32 input data elements simultaneously, and the network parameters are updated once according to the weighting of the loss values of the 32 input data elements.

During the inference process, the model will combine the key tensors and value tensors obtained from the self-attention mechanism for calculation. For example, the model is configured with an encoder or other structured sub-network to use the self-attention mechanism to encode input data elements and obtain semantic features corresponding to the input data elements. For example, the semantic features include key tensors and value tensors corresponding to input data elements belonging to a batch of input data. The key tensors and value tensors are stored in the storage space of the processor for subsequent inference on tokens. Under the circumstances, the key tensors and value tensors have the same size and are proportional to the product of the maximum length of input text corresponding to the batch of input data and the batch size.

When performing token inference for the first time, the semantic features include original key tensors and value tensors. Under the circumstances, the size of the key tensors and value tensors is smallest throughout the entire token inference process. After obtaining the output token predicted for the first time, the semantic features are updated, and the updated semantic features include updated key tensors and updated value tensors, where the updated key tensors and the updated value tensors carry information of the output token predicted for the first time, and so on. Therefore, as token inference continues, the size of the key tensors and the value tensors used for token inference will grow correspondingly one by one as the inference length progresses step by step, that is, the length of the key tensors and the value tensors is proportionally related to the number of output tokens that have been predicted, and the storage space occupied by the key tensors and the value tensors also increases progressively.

Taking the GPT-3 model as an example, the GPT-3 model has 175 billion parameters and an output token length of up to 2048, that is, the number of tokens (inference length or number of inference steps) of a longest output token sequence supported by the GPT-3 model may reach 2048. The model, with up to 175 billion parameters, will occupy approximately 350GB of storage space (for parameters formatted in FP16). In a typical single or dual-node system, assuming the total storage capacity of its graphics card is 512 GB, approximately 160 GB of storage space remains after deducting the 350 GB required for fixed weight parameters. During the inference process, the size of the key tensors and the value tensors is proportional to the batch size multiplied by (the maximum length of the input text corresponding to this batch of input data plus the number of tokens predicted/inference steps executed). Consequently, as inference progresses, the storage space required by the key tensors and the value tensors will progressively increase.

In the inference process, it is generally desirable to have a larger batch size to more efficiently utilize the tensor computation operators available in the processor and to enhance the resource utilization of the processor. However, for a given batch of input data, in order to accommodate the key tensors and the value tensors in the storage space at the final moment (when the inference on the batch of input data is complete), the batch size for model inference needs to correspond to the inference steps at the final moment. Specifically, the product of the batch size and the maximum number of inference steps (which is the sum of the number of tokens of the longest output sequence supported by the neural network and the maximum length of the input data elements supported by the neural network) needs to be less than a specified limit. In the early stages of inference, the number of inference steps executed is relatively small, and the key tensors and value tensors stored in the storage space have not yet fully occupied all available storage space. At this time, due to the small batch size, the computational power of the system cannot be fully utilized, thus limiting the overall computational power available for the inference process.

At least one embodiment of the present disclosure provides a data processing method and apparatus, an electronic device, and a non-transitory storage medium. The data processing method includes: performing an inference operation on data to be processed through a neural network, and the inference operation includes: using the neural network to perform M rounds of inference successively on the data to be processed, wherein the data to be processed includes multiple batches of input data, each batch of the input data includes N1 input data elements, and the entire inference process is completed on only one batch of the input data in each round of inference, and M and N1 are positive integers greater than 1. The M rounds of inference include an i-th round of inference and an (i+1)-th round of inference executed successively in order, i is a positive integer and less than M, wherein the inference process of the i-th round of inference includes: at a first stage of the inference process of the i-th round of inference, performing inference on N2 input data elements, at a second stage of the inference process of the i-th round of inference, performing inference on N1 input data elements to complete the entire inference process on the N1 input data elements belonging to the same batch of input data; wherein the first stage is earlier than the second stage, N2 is greater than N1, and the N1 input data elements belonging to the same batch of the input data are a subset of the N2 input data elements. The inference process of the (i+1)-th round of inference includes: for N2-N1 input data elements for which the inference is incomplete in the i-th round of inference but for which output tokens have been acquired through the inference, performing inference on the N2-N1 input data elements while taking into account the output tokens.

The data processing method provided by at least one embodiment of the present disclosure introduces an inference mode with variable batch size. In the stage where the number of inference steps is small and the key tensors and value tensors occupy less storage space (i.e., the first stage), a larger batch size is adopted to improve computational efficiency and fully utilize the computing power of operators in the processor. As inference continues (i.e., the second stage), the key tensors and value tensors gradually occupy more storage space, the batch size is reduced to complete inference, thereby accelerating the overall inference process, fully utilizing system computing power, and improving inference efficiency and computing power utilization.

The data processing method provided by the embodiments of the present disclosure may be applied to the data processing apparatus provided by the embodiments of the present disclosure, and the data processing apparatus may be configured on an electronic device. The electronic device may be a personal computer, a mobile terminal, etc., and the mobile terminal may be a hardware device such as a mobile phone, a tablet computer, a laptop computer, etc.

The embodiments of the present disclosure are described in detail below in combination with the accompanying drawings, but the present disclosure is not limited to these specific embodiments.

For example, the data processing method provided by at least one embodiment of the present disclosure includes: performing an inference operation on data to be processed through a neural network.

For example, the data to be processed may be a data set, including all data that the neural network needs to process.

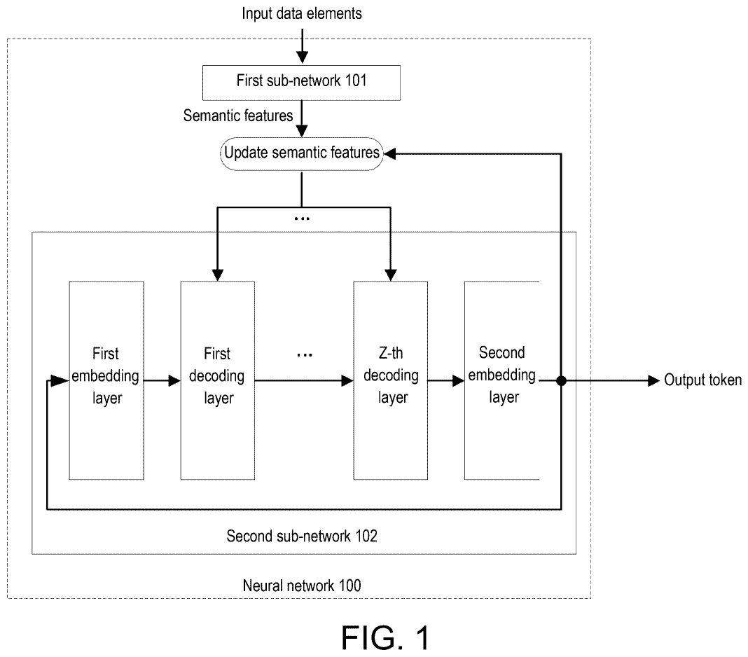

FIG. 1 is a schematic structural view of a neural network provided by at least one embodiment of the present disclosure.

As shown in FIG. 1, a neural network 100 for executing the data processing method provided by at least one embodiment of the present disclosure includes a first sub-network 101 and a second sub-network 102.

For example, the first sub-network 101 is configured to receive input data elements, and combined with a self-attention mechanism to extract semantic features corresponding to the input data elements, where the semantic features include initial key tensors and initial value tensors.

For example, the second sub-network 102 is configured to predict output token sequences corresponding to the input data elements one by one based on semantic features in combination with an autoregressive mechanism.

For example, for example, the neural network is a GPT network, correspondingly, when using the neural network to perform inference, the inference includes prompt inference based on the first sub-network 101, and token inference based on the second sub-network 102.

In the model inference process, it is necessary to provide initial text (input data elements) as a prompt, and then the GPT network will continue to generate related text according to the prompt. For example, the initial text may be text input by a user, such as questions, requests, emotional expressions, random chats, and other categories.

In the prompt inference process, the first sub-network 101 is configured to receive the input data elements, and combined with the self-attention mechanism to extract semantic features corresponding to the input data elements, for example, the semantic features include initial key tensors and initial value tensors as intermediate cache. For example, in the prompt inference process, the input data elements belonging to the same batch of input data may all be input to the first sub-network 101. After computation, corresponding initial key tensors and initial value tensors are generated and stored in the storage space of the processor for subsequent token inference. For example, since inference is performed in batches during inference, lengths of the input data elements in the same batch may vary. Before being entered into the neural network for processing, the input data elements in the same batch may all be padded to the same length, for example, by padding predefined blank tokens (such as “<pad>”) after the input data elements so that the lengths of the input data elements reach the maximum length of input text corresponding to the batch of input data.

For example, as mentioned above, for a batch of input data, the initial key tensors and initial value tensors generated through the first sub-network 101 have the same length, and are proportional to a product of a maximum length of input text corresponding to the batch of input data and a batch size of the batch of input data.

After that, in the token inference process, the second sub-network 102 is configured to predict output token sequences corresponding to the input data elements one by one based on the semantic features in combination with the autoregressive mechanism. For example, the second sub-network 102 is configured to combine the semantic features with already predicted output tokens to predict output tokens one by one.

As shown in FIG. 1, the second sub-network 102 includes a first embedding layer, multiple decoding layers, and a second embedding layer.

The first embedding layer is configured to convert input tokens to corresponding token indices, and encode the token indices to obtain input vectors corresponding to the input tokens. For example, a mapping table including all possible tokens is preset. The mapping table provides mapping relationships between various user input tokens and their corresponding token indices. The tokens and their corresponding token indices have one-to-many or many-to-one mapping relationships, the corresponding rules are determined by a tokenizer, and the token indices are, for example, floating point numbers or integers. The token indices have a one-to-one correspondence relationship with the input vectors obtained by encoding, and the correspondence relationship is determined by an embedding table.

For example, when performing prediction for the first time, the input token is a tag used to indicate the start of character text, such as “<SS>” or “<BOS>”, or the tag may also be a tag used to indicate that the text content of the previous round of prediction has ended, such as “<EOS>”, or the tag may also be other tags depending on the task, etc. The present disclosure is not limited thereto, and the purpose of the tag is to predict what the token at the next position is.

For example, after predicting a first output token, the input token is a predicted output token. For example, the first output token is input as an input token to the second sub-network 102 for processing to obtain a predicted second output token. Thereafter, the predicted second output token is used as an input token and input to the second sub-network 102 for recognition to obtain a predicted third output token, and so on, until an end tag is output, for example “<EOS>” is output, thus completing one round of token inference and obtaining an output token sequence corresponding to the input data element.

For example, multiple decoding layers are cascaded. A first decoding layer is configured to process the semantic features and input tokens to obtain a processing result; a second decoding layer is configured to process the semantic features and the processing result of a first decoder to obtain a processing result; . . . ; a j-th decoding layer is configured to process the semantic features and the processing result output by a (j−1)-th decoding layer to obtain a processing result, where L is a positive integer greater than 1, and j is a positive integer greater than 1 and less than or equal to Z.

For example, as shown in FIG. 1, in the token inference process, the second sub-network 102 will continuously update the semantic features according to the output tokens predicted through each inference, so that the semantic features used in the token inference process will grow correspondingly as the inference length increases one by one, and the updated semantic features will carry information of the already predicted tokens.

For example, when performing prediction for the first time, the semantic features include initial key tensors and initial value tensors from the first sub-network 101. After obtaining the output tokens output from the first prediction, the semantic features are updated, and the updated semantic features include updated key tensors and updated value tensors, where the updated key tensors and updated value tensors carry information of the output tokens output from the first prediction, and so on. Therefore, lengths of the updated key tensors and updated value tensors are in direct proportion to the number of the output tokens corresponding to the input data elements that have been acquired from the prediction. For a batch of input data, the sizes of the updated key tensors and updated value tensors are proportional to the batch size of the batch of input data multiplied by (maximum length of input text corresponding to the batch of input data plus number of output tokens predicted/number of inference steps executed).

Of course, it is important to note that the neural network depicted in FIG. 1 represents a schematic structure. The data processing method provided in the present disclosure is applicable to neural networks of other structures, such as those where intermediate cache variables used for data processing during inference grow in size as inference progresses. The present disclosure does not impose specific limitations on such applications.

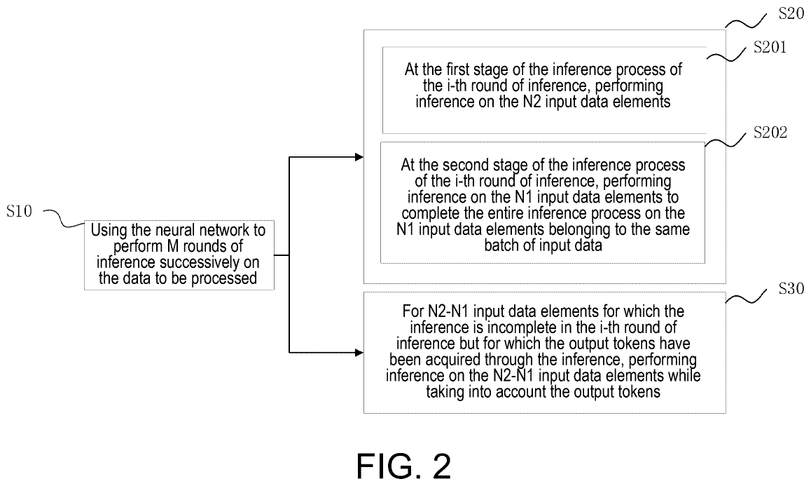

FIG. 2 is a flowchart of an inference operation provided by an embodiment of the present disclosure.

As shown in FIG. 2, the inference operation includes step S10, using the neural network to perform M rounds of inference successively on the data to be processed.

For example, the data to be processed (such as a dataset) includes multiple batches of input data. Each batch of the input data includes N1 input data elements, that is, the batch size is N1, where M and N1 are positive integers greater than 1.

For example, as mentioned above, the data to be processed for inference may be divided into multiple batches. Each batch of the input data includes N1 input data elements, and each input data element may be the minimum unit processed by the neural network, for example, one input data element may be in the form of a sentence input by a user.

For example, the entire inference process is completed on only one batch of the input data in one round of inference, that is, at the final moment of one round of inference, the inference on one batch of input data including all input data elements is completed, and the output token sequences corresponding to the all input data elements in the batch of input data are obtained. Therefore, in the present disclosure, one round of inference refers to completion of the entire inference process on one batch of the input data, rather than referring to completion of the inference of all data to be processed through the neural network. For example, if the data to be processed includes M batches of input data, then the entire inference process on the M batches of input data may be completed through the M rounds of inference.

For example, the M rounds of inference include the i-th round of inference and the (i+1)-th round of inference executed sequentially in order, where i is a positive integer and less than M. For example, the (i+1)-th round of inference is executed immediately after the i-th round of inference is executed.

As shown in FIG. 2, step S10 may include step S20 describing the inference process of the i-th round of inference and step S30 describing the inference process of the (i+1)-th round of inference.

For example, as shown in FIG. 2, step S20 may include step S201 and step S202.

Step S201 may include: at the first stage of the inference process of the i-th round of inference, performing inference on the N2 input data elements.

Step S202 may include: at the second stage of the inference process of the i-th round of inference, performing inference on the N1 input data elements to complete the entire inference process on the N1 input data elements belonging to the same batch of input data.

For example, the first stage is earlier than the second stage, N2 is greater than N1, and the N1 input data elements belonging to the same batch of input data are a subset of the N2 input data elements.

Step S30 may include: for N2-N1 input data elements for which the inference is incomplete in the i-th round of inference but for which the output tokens have been acquired through the inference, performing inference on the N2-N1 input data elements while taking into account the output tokens.

For example, N1 is determined by the number of tokens of the longest output token sequence supported by the neural network and the size of the storage space used to store the updated key tensors and the updated value tensors. As mentioned above, the size of the updated key tensors and the updated value tensors is proportional to the batch size multiplied by (maximum length of input text corresponding to the batch of input data plus number of tokens predicted/number of inference steps executed). For a given batch of input data, in order to accommodate the updated key tensors and the updated value tensors in the storage space at the final moment (when the inference on the batch of input data is complete), the batch size of model inference needs to match the number of inference steps at the final moment. That is, a product of N1 and a sum of the number of tokens step_t (which may be 2048 for GPT-3, for example) of the longest output token sequence supported by the neural network and a maximum length P of the input text corresponding to the batch of input data should be less than an upper limit, which is determined by the storage space for storing the key tensors and the value tensors.

In the present disclosure, at the first stage of one round of inference, for example, the early-to-middle stage of inference, inference is performed on the input data with a larger batch size (such as N2), which includes inference on the N1 input data elements belonging to the same batch of input data. At the second stage, for example, the later stage of inference, the batch size is reduced to N1, that is, at the second stage, the inference is performed on the N1 input data elements until the entire inference process on the N1 input data elements is completed, thus completing one round of inference.

Thus, at the first stage, a larger batch size can make computations such as matrix multiplication and mapping in the neural network more efficient, improving computational efficiency. Therefore, under the circumstances, the operational efficiency is higher than performing inference on only the N1 input data elements, and can fully utilize the computational power of operators in the processor. Since these computations occupy most of the operations and weight loading in the entire inference process, improving the computational speed of this part can accelerate the overall inference process, fully utilize system computational power, and improve inference efficiency and computational power utilization.

It should be noted that in the present disclosure, variable batch size refers to the variable number of input data elements processed simultaneously by the neural network, for example, processing multiple batches of input data simultaneously, or processing one batch of input data. A larger batch size refers to performing inference on more input data elements simultaneously in the early stage of inference, rather than referring to the variable batch size of each batch of input data.

The specific inference process of each round of inference is specifically described below in combination with the accompanying drawings.

For example, step S201 in the i-th round of inference may include: determining X batches of input data as the N2 input data elements; performing inference on the X batches of input data simultaneously in units of batches.

For example, the X batches of input data include a first batch of input data Batch1. The first batch of input data Batch1 includes N1 input data elements for which the entire inference process is complete in the i-th round of inference, and X is a positive integer greater than 1. That is to say, the input data Batch1 is the only batch of input data for which the entire inference process needs to be complete in the i-th round of inference, and the inference process is incomplete for the other X−1 batches of input data in the i-th round of inference.

For instance, the batch size of each batch of input data within the X batches of input data is identical, and is denoted as N1. For example, N2 is an integer multiple of N1, such that N2=X*N1. Naturally, the batch sizes of the X batches of input data may also vary, and this disclosure imposes no specific restrictions in this regard.

For example, determining the X batches of input data as the N2 input data elements may include: in response to i being equal to 1, determining the X batches of input data for which the inference is entirely not performed as the X batches of input data; in response to i being greater than 1: determining X−1 batches of input data for which the inference is incomplete in the (i−1)-th round of inference, together with one batch of input data for which the inference is entirely not performed, as the X batches of input data, wherein the first batch of input data is determined from the X−1 batches of input data for which the inference is incomplete in the (i−1)-th round of inference.

For example, for the first round of inference, the inference is not yet performed on all batches of input data, and the X batches of input data are arbitrarily selected from them as the N2 input data elements to perform the first stage of inference.

For example, for the other M−1 rounds of inference except the first round of inference, such as for the second round of inference, assume that in the first round of inference, input data Batch_1, input data Batch_2 to input data Batch_X, a total of X batches of input data, are selected as the N2 input data to be inferred in the first round of inference, wherein the input data Batch_1is the first batch of input data for which the entire inference process is complete in the first round of inference. The input data Batch_2 to the input data Batch_X for which the inference is incomplete in the first round of inference, as well as one batch of input data Batch X+1 for which the inference is entirely not performed, are selected as the X batches of input data serving as the N2 input data elements used in the second round of inference.

For the first round of inference, the first batch of input data for which the entire inference process is complete in the first round of inference may be selected from any batch of input data among the X batches of input data.

For the other M−1 rounds of inference except the first round of inference, the first batch of input data needs to be determined from the X−1 batches of input data for which the inference is incomplete in the (i−1)-th round of inference. For example, for the second round of inference, any batch of input data from the input data Batch_2 to the input data Batch_X may be selected as the first batch of input data for which the entire inference process is complete in the second round of inference. That is to say, in the second round of inference and subsequent inference processes, the N1 input data elements for which the entire inference process is complete in each round need to be subjected to some inference in at least the previous round of inference.

For example, the X−1 batches of input data except the first batch of input data among the X batches of input data have respective corresponding inference suspension thresholds, and the inference suspension thresholds are used to indicate that, in the i-th round of inference, if the number of output tokens that have been acquired through the inference for any batch of input data among the X−1 batches of input data reaches the corresponding inference suspension threshold, the inference on the batch of input data is suspended.

There is no corresponding inference suspension threshold for the first batch of input data, that is, at the first stage, the first batch of input data will be subjected to inference continuously until the other X−1 batches of input data all reach their respective inference suspension thresholds and are suspended, after which the first stage ends.

For example, when the number of output tokens that have been acquired through the inference for any batch of input data reaches the corresponding inference suspension threshold, suspending the inference on the any batch of input data may include: suspending the inference on the any batch of input data; storing the output tokens that have been acquired through the inference for the any batch of input data; clearing the updated key tensors and the updated value tensors generated for the any batch of input data during the i-th round of inference.

For example, storing the output tokens that have been acquired through the inference for any batch of input data may include: converting each output token among the output tokens that have been acquired through the inference for the any batch of input data to a corresponding token index; storing the token indices respectively corresponding to the output tokens that have been acquired through the inference for the any batch of input data.

For example, taking the first round of inference as an example, the input data Batch_2 corresponds to an inference suspension threshold s2, the input data Batch_3 corresponds to an inference suspension threshold s3, . . . , and the input data Batch_X corresponds to an inference suspension threshold sx.

For example, at the beginning of the first stage of the first round of inference, inference is performed simultaneously on the input data Batch_1 to the input data Batch_X respectively in batches, that is, at the first stage, the number of input data elements being subjected to the inference simultaneously is X*N1. When the number of output tokens that have been acquired through the inference for the input data Batch_2 reaches s2, the continued inference on the input data Batch_2 is suspended, and the output tokens that have been acquired through the inference for the input data Batch_2 are converted to the token index and stored in the storage space. In the meantime, the updated key tensors and the updated value tensors generated by performing inference on the input data Batch_2 in the i-th round of inference are cleared. Since the storage space occupied by the token index is extremely small, the continued inference on the input data Batch_1 in the subsequent second stage will not be affected.

Similarly, when the number of output tokens that have been acquired through the inference for the input data Batch_X reaches sx, the continued inference on the input data Batch_X is suspended, and the output tokens that have been acquired through the inference for the input data Batch X are converted to the token index and stored in the storage space. In the meantime, the updated key tensors and the updated value tensors generated by performing inference on the input data Batch_X in the i-th round of inference are cleared.

At the first stage, the inference on the first batch of input data Batch_1 continues, and when the input data Batch_2 through the input data Batch_X all reach their respective corresponding inference suspension thresholds and are suspended, the first stage ends.

For example, the inference suspension thresholds corresponding to each batch of input data may be different or the same. For example, if X=2, the inference suspension thresholds corresponding to each batch of input data may be the same. For example, if X is greater than 2, the inference suspension thresholds corresponding to the other X−1 batches of input data except the first batch of input data among the X batches of input data being subjected to the inference in the same round of inference may be different.

For example, the inference suspension thresholds corresponding to each batch of input data are related to the number of tokens of the longest output token sequence supported by the neural network, the maximum length of input text corresponding to a batch of input data supported by the neural network, the number of input data elements currently being subjected to the inference, etc.

For example, in response to X=2, the inference suspension thresholds corresponding to each batch of input data are the same and are all calculated as (L−2P)/3, where P is the maximum length of input text corresponding to a batch of input data supported by the neural network, L is the sum of the number of tokens of the longest output token sequence supported by the neural network and P, and “/” represents division.

For example, taking the inference suspension threshold s2 corresponding to the input data Batch_2 as an example, assuming s2 is the minimum value among all inference suspension thresholds, when the number of output tokens that have been acquired through the inference for the input data Batch_2 reaches s2, the number of output tokens that have been acquired through the inference for the other X−1 batches of input data such as the input data Batch_1 and the input data Batch X also all reach s2. Under the circumstances, the updated key tensors and the updated value tensors generated by each batch of input data during the inference process have occupied all the storage space, so the inference on the input data Batch_2 may be suspended, the updated key tensors and the updated value tensors generated by the input data Batch_2 may be cleared, and the output tokens that have been acquired through the inference for the input data Batch_2 may be stored in the storage space in the form of token index.

Afterwards, the inference process continues for the other X−1 batches of input data, and the available storage space generated by clearing the updated key tensors and the updated value tensors generated by the input data Batch_2 may be used to store the updated key tensors and the updated value tensors generated by the other X−1 batches of input data during the continued inference process, until the storage space is fully occupied again. For example, under the circumstances, the number of output tokens that have been acquired through the inference for the other X−1 batches of input data all reach the inference suspension threshold s3 corresponding to the input data Batch_3 (s3 is greater than s2 but less than other inference suspension thresholds). The inference on the input data Batch_3 is suspended, the updated key tensors and the updated value tensors generated by the input data Batch_3 during the inference process are cleared, and the inference process continues for the other X−2 batches of input data (other batches of input data except the input data Batch_2 and the input data Batch_3). The available storage space generated by clearing the updated key tensors and the updated value tensors generated by the input data Batch_3 may be used to store the updated key tensors and the updated value tensors generated by the other X−2 batches of input data during the continued inference process.

The above process is executed until the X−1 batches of input data except the first batch of input data are all suspended, and the first stage ends.

For example, performing inference on the X batches of input data simultaneously may include: in response to i being greater than 1, for the other X−1 batches of input data among the X batches of input data except one batch of input data for which the inference is entirely not performed, for the N2-N1 input data elements for which the inference is incomplete in the i-th round of inference but for which the output tokens have been acquired through the inference, performing inference on the other X−1 batches of input data elements while taking into account the output tokens.

For example, in the first round of inference, the inference may be performed on the X batches of input data according to a conventional neural network inference process, for example, prompt inference and token inference may be performed with reference to the related description of FIG. 1.

For example, in other rounds of inference except the first round of inference, for a batch of input data for which the inference is entirely not performed in that round of inference, a conventional neural network inference process is also applicable for inference, which will not be elaborated here. For the other X−1 batches of input data among the X batches of input data except one batch of input data for which the inference is entirely not performed, these input data have already been subjected to some inference in the previous round of inference or previous rounds of inference, and the output tokens that have been acquired through the inference have been stored. Therefore, the X−1 batches of input data may be subjected to the inference in combination with the output tokens that have been previously acquired through the inference, thereby accelerating the overall inference process.

For example, in that round of inference, the output tokens that have been acquired through the inference and the original input data may be jointly used as new input to be input into the neural network for processing. For example, after passing through the first sub-network, the obtained semantic features may include information of the output tokens that have been acquired through the inference. When using the second sub-network to perform token inference, inference may directly advance to start from the last token among the output tokens that have been acquired through the inference. Under the circumstances, the lengths of the initial key tensors and the initial value tensors obtained through the first sub-network is in positive proportion to the sum of the maximum length of the input text corresponding to that batch of input data and the number of output tokens that have been acquired through the inference.

Thus, in each round of inference, multiple batches of input data are processed, and the other X−1 batches of input data except the first batch of input data are also subjected to some inference, so that some inference is additionally performed on the other X−1 batches of input data in each round of inference, thereby accelerating the inference overall. Moreover, the weight loading time is the same, and at the first stage, since the N2 input data elements are subjected to the inference simultaneously, the inference speed is basically not affected, and the computational efficiency and utilization of the processing core may be increased.

The specific process of performing inference on the X−1 batches of input data in combination with the output tokens that have been previously acquired through the inference may be derived from the related description of step S30 described below, which will not be elaborated here.

For example, step S202 may include: at the second stage of the inference process of the i-th round of inference, inference is performed continuously on the first batch of input data until completing the inference on all input data elements in the first batch of input data. For example, the first batch of input data includes the N1 input data elements for which the entire inference process is performed in the i-th round of inference.

At the first stage, the other X−1 batches of input data except the first batch of input data all reach their respective inference suspension thresholds and are suspended, and at the second stage, the first batch of input data continues to be subjected to the inference until the entire inference process is performed on the N1 input data elements included in the first batch of input data, thereby completing the i-th round of inference.

The (i+1)-th round of inference may also include the first stage and the second stage.

For example, at the first stage, first the X batches of input data are determined as the N2 input data elements for which inference is performed in the (i+1)-th round of inference. Similar to the i-th round of inference, the N2 input data elements may include the N2-N1 input data elements for which the inference is incomplete in the i-th round of inference, and one batch of input data (N1 input data elements) for which the inference is entirely not performed. For example, in the (i+1)-th round of inference, the N1 input data elements among the N2-N1 input data elements for which the inference is incomplete in the i-th round of inference are determined as the first batch of input data for which the inference needs to be completed in the (i+1)-th round of inference.

Thereafter, at the first stage, the N2 input data elements are subjected to the inference in batches.

Similar to the i-th round of inference, for one batch of input data among the N2 input data elements for which the inference is entirely not performed, the inference process may be performed according to a conventional neural network inference process. For the N2-N1 input data elements for which some inference has been performed in the i-th round of inference, for the N2-N1 input data elements for which the inference is complete in the i-th round of inference and for which the output tokens have been acquired through the inference, the inference is performed on the N2-N1 input data elements while taking into account the output tokens.

For example, step S30 may include: obtaining output tokens that have been acquired through the inference for the N2-N1 input data elements in the i-th round of inference, wherein the output tokens that have been acquired through the inference for the N2-N1 input data elements are stored in the storage space in the form of token index. The inference is performed on the N2-N1 input data elements in batches, wherein for each input data element among the N2-N1 input data elements, the obtained output tokens that have been acquired through the inference for the input data elements and the input data elements are input together into the neural network for inference.

For example, inputting the obtained output tokens that have been acquired through the inference for the input data elements and the input data elements together into the neural network for inference may include: concatenating token indices corresponding to the output tokens that have been acquired through the inference for the input data elements with token indices corresponding to the input data elements, and inputting a concatenation result into the neural network for inference.

For example, taking the second round of inference as an example, the N2-N1 input data elements include the input data Batch_2 to the input data Batch_X that have been subjected some inference in the first round of inference. For example, for the input data Batch_2, s2 steps of inference have been performed in the first round of inference, that is, each input data element in the input data Batch_2 has output s2 output tokens, and are stored in the storage space in the form of token index.

Token indices corresponding to the s2 output tokens corresponding to each input data element are extracted from the storage space, and the s2 output token indices are concatenated with the token indices corresponding to the input data element. The concatenation results are used as new input data elements, and each new input data element is input into the neural network in batches for inference.

For example, after passing through the first sub-network, the obtained semantic features may contain information of the s2 steps of inference that have been executed. When using the second sub-network to perform token inference, inference may directly advance to start from the last token among the output tokens that have been acquired through the inference.

For example, the neural network includes the first sub-network for performing prompt inference and the second sub-network for performing token inference. For example, the prompt inference includes using the first sub-network to extract semantic features corresponding to the input data elements. For example, the token inference includes predicting the output token sequences corresponding to the input data elements one by one based on the extracted semantic features in combination with the autoregressive mechanism. For specific processes of the prompt inference and the token inference, reference may be made to the related descriptions of the aforementioned neural network, which will not be elaborated here.

For example, while performing the prompt inference on the N2-N1 input data elements through the first sub-network, the prompt inference is performed on a batch of input data for which the inference is entirely not performed through the first sub-network. After the prompt inference is complete for both the N2-N1 input data elements and the one batch of input data for which the inference is entirely not performed, the token inference is simultaneously initiated on the N2-N1 input data elements and the one batch of input data for which the inference is entirely not performed through the second sub-network.

For example, still taking the second round of inference as an example, the concatenated new input data elements obtained through the aforementioned process are input into the first sub-network in batches for prompt inference to obtain semantic features corresponding to each new input data element. In the meantime, the first sub-network is used to perform the prompt inference on a batch of input data (for example, input data Batch_X+1) for which the inference is entirely not performed to obtain semantic features of the batch of input data.

After the prompt inference is complete for both the N2-N1 input data elements and the input data Batch_X+1, token inference for both of the above is simultaneously initiated. For example, for the N2-N1 input data elements, semantic features containing information of output tokens that have been acquired through the inference may be used to directly advance inference to the last token among the output tokens that have been acquired through the inference, thereby accelerating inference.

For example, for the other X−1 batches of input data except the first batch of input data among the N2 input data elements processed in the i+1-th round of inference, when the number of output tokens that have been acquired through the inference in the i+1-th round of inference reaches the corresponding inference suspension threshold, the inference is suspended, and the specific process is as described in the related description of step S201, which will not be elaborated here.

Thereafter, at the second stage, the inference continues on the first batch of input data in the i+1-th round of inference until the entire inference process on the first batch of input data is completed, thereby completing the i+1-th round of inference.

The above process is repeated until the entire inference process on the data to be processed is completed.

For example, if i+1 equals M, for the M-th round of inference, in some embodiments, there may be no more input data, for which the inference is entirely not performed, requiring the inference. In this case, the M-th round of inference may not include the first stage, and only step S30 is executed to complete the entire inference process on the N2-N1 input data elements for which the inference is incomplete in the i-th round of inference.

In the data processing method provided by at least one embodiment of the present disclosure, in the early stage of a round of inference, such as the first stage, a larger batch size is adopted, for example, the inference is performed on multiple batches of input data simultaneously. For systems with redundant computing power, it is possible to improve computing power utilization in this part of inference, thereby improving overall inference efficiency. In the later stage of a round of inference, such as the second stage, the batch size is reduced to N1 to enable completion of the entire inference process on one batch of input data. Thus, system computing power is fully utilized in each round of inference, and some inference is additionally executed on the N2-N1 input data elements, which may accelerate the overall inference process and improve system computational efficiency and computing power utilization efficiency.

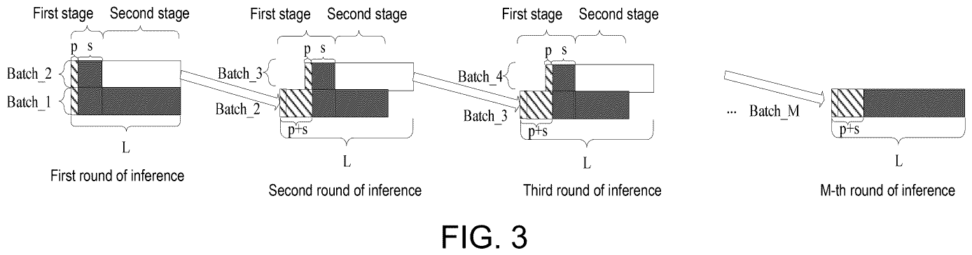

FIG. 3 is a schematic view of an execution process of a data processing method provided by an embodiment of the present disclosure.

For instance, in the example illustrated in FIG. 3, assume that for each batch of input data, the batch size*(step_t+P) needs to comply with an upper limit imposed by storage space constraints, wherein a maximum permissible value for the batch size is N1. Here, step_t denotes the number of tokens of the longest output token sequence supported by the neural network, and P represents the maximum length of the input text corresponding to a batch of input data supported by the neural network. The batch size for each batch of input data is N1, meaning that the entire inference process on the N1 input data elements is completed in each round of inference.

For example, in the example of FIG. 3, it is shown that the entire inference process on the input data Batch_1, the input data Batch_2, the input data Batch_3, . . . , and the input data Batch_M is completed through the M rounds of inference. The batch sizes of the input data Batch_1 through the input data Batch_M are all N1, N2 is twice N1, X=2. That is, at the first stage, the inference is performed on 2 batches of input data simultaneously, and at the second stage, the inference is performed on 1 batch of input data.

For example, the neural network used when executing the data processing method may refer to the structure and inference process of the neural network in the aforementioned FIG. 1, which will not be elaborated here.

In FIG. 3, boxes located in the same row represent the inference process of one Batch (one batch of input data). For example, in the first round of inference, the boxes in the upper row represent the inference process of the input data Batch_2, and the boxes in the lower row represent the inference process of the input data Batch_1.

For example, for one Batch, the diagonal line box portion represents prompt inference completed by the first sub-network, the remaining portion represents token inference completed by the second sub-network, and in the remaining portion, gray boxes represent executed inference, and white boxes represent portions for which the inference is not yet performed.

For example, for one Batch, p represents the maximum length of input text corresponding to one batch of input data supported by the neural network. For one batch of input data, if the lengths of individual input data elements are different, they are all padded to the maximum length p through padding. The specific process is as described above and will not be elaborated here. L represents the longest inference step to complete the entire inference process on one batch of input data. This longest inference step is proportional to the lengths of the updated key tensors and the updated value tensors at the final moment of the one round of inference. This longest inference step is calculated as L=p+step_t, where step_t represents the number of tokens (that is, the longest inference step of token inference) of the longest output token sequence supported by the neural network; s represents the inference suspension threshold. In the example of FIG. 3, the inference suspension thresholds corresponding to the input data Batch_2 through the input data Batch_M are all s, indicating that during the token inference process, when the number of output tokens obtained from the current round of inference reaches s, the inference on the batch of input data is suspended.

The execution process of the data processing method provided by at least one embodiment of the present disclosure will be specifically described below in combination with FIG. 3.

In the first round of inference, as shown in FIG. 3, at the first stage, two input data with batch size of N1 are selected from the data to be processed to start inference simultaneously. For example, the input data Batch_1 and the input data Batch_2 are selected as the N2 input data elements processed at the first stage, where the input data Batch_1 is selected as the first batch of input data in the first round of inference, that is, in the first round of inference, the entire inference process on the input data Batch_1 needs to be completed.

For example, at the first stage, the inference process is performed on each of the input data Batch_1 and the input data Batch_2 respectively. The inference process includes executing p steps of prompt inference first, and performing token inference based on the semantic features generated by the prompt inference. The specific process may refer to the related description of

During the token inference process, the updated key tensors and the updated value tensors continuously grow, occupying more and more storage space. For example, when the inference on the input data Batch_1 and the input data Batch_2 proceeds to the s-th step (outputting s output tokens), the inference suspension threshold corresponding to the input data Batch_2 is reached. At this time, the updated key tensors and the updated value tensors of the input data Batch_1 and the input data Batch_2 have fully occupied the storage space. The inference on the input data Batch_2 is suspended, and the output tokens already acquired through the inference for the input data Batch_2 are stored, for example, stored in the storage space in the form of token index. The updated key tensors and the updated value tensors generated by the input data Batch_2 during the first round of inference are cleared, and the first stage ends.

The space occupied by the token indices corresponding to the output tokens already acquired through the inference for the stored input data Batch_2 is extremely small and can be ignored, and does not affect the storage of the updated key tensors and the updated value tensors generated by the input data Batch_1 in the inference at the second stage.

At the second stage, as shown in FIG. 3, the inference on the input data Batch_2 is suspended, and the inference on the input data Batch_1 continues until the inference on all input data elements in the input data Batch_1 is completed, thereby completing the first round of inference. For example, after completing the first round of inference, the storage space occupied by the updated key tensors and the updated value tensors of the input data Batch_1 may be released to perform the second round of inference.

In the first round of inference, the entire inference process is performed on the input data Batch_1, and s steps of inference are performed on the input data Batch_2.

It is necessary to clarify that the terms “first stage” and “second stage” are descriptive and do not imply that the inference process must suspend after the first stage and then resume at the second stage. For instance, in the case of the input data Batch_1, the token inference process is continuous. Any operations related to suspending the inference on the input data Batch_2 may be completed before step s+1 is performed on the input data Batch_1.

In the second round of inference, as shown in FIG. 3, at the first stage, one input data Batch_3 with a batch size of N1 and for which the inference is entirely not performed, along with the input data Batch_2 for which the inference is incomplete in the first round of inference, are selected from the data to be processed to start inference. For example, the input data Batch_2 and the input data Batch_3 are selected as the N2 input data elements processed at the first stage, where the input data Batch_2 is selected as the first batch of input data in the second round of inference, that is, in the second round of inference, the entire inference process on the input data Batch_2 needs to be completed.

For example, at the first stage, the inference process is performed on each of the input data Batch_2 and the input data Batch_3 respectively.

As shown in FIG. 3, while performing the prompt inference on the input data Batch_2 through the first sub-network, the prompt inference is performed on the input data Batch_3 through the first sub-network. After the prompt inference is performed on both the input data Batch_2 and the input data Batch_3, the token inference is simultaneously initiated on the input data Batch_2 and the input data Batch_3 through the second sub-network.

The prompt inference performed on the input data Batch_3 is the same as the conventional process, which will not be elaborated here.

For the input data Batch_2, it is necessary to take into account the inference results (output tokens that have been acquired through the inference) of the s steps of inference already executed in the first round of inference to perform the inference on the input data Batch_2. Specifically, as described in step S30, for each input data element in the input data Batch_2, the token indices corresponding to the output tokens that have been acquired through the inference and the token indices corresponding to the input data elements are concatenated, and the concatenation results are used as new input data elements, and these new input data elements are subjected to the inference through the neural network. The prompt inference process for the new input data elements is the same as the conventional prompt inference process, but the length is (p+s). The initial key tensors and the initial value tensors obtained through the new input data elements contain information related to the inference results of the s steps of inference already executed in the first round of inference. When performing the token inference on the input data Batch_2, the reference may directly advance to the s-th step of inference without repeating the inference of the previous s steps that have been executed in the first round of inference.

In the token inference process, the updated key tensors and the updated value tensors continuously grow, occupying more and more storage space. For example, when the inference on the input data Batch_3 proceeds to the s-th step (outputting s output tokens), the inference suspension threshold corresponding to the input data Batch_3 is reached. At this time, the updated key tensors and the updated value tensors of the input data Batch_2 and input data Batch_3 have fully occupied the storage space, the inference on the input data Batch_3 is suspended, the output tokens that have been acquired through the inference the for input data Batch_3 are stored, for example, stored in the storage space in the form of token index, the updated key tensors and the updated value tensors generated by the input data Batch_3 in the second round of inference are cleared, and the first stage ends.

At the second stage, as shown in FIG. 3, the inference on the input data Batch_3 is suspended, the inference on the input data Batch_2 continues until the inference on all input data elements in the input data Batch_2 is completed, thereby completing the second round of inference.

In the second round of inference, the entire inference process is performed on the input data Batch_2, and the inference process on the input data Batch_3 has been proceed s steps.

The subsequent third round of inference through the (M−1)-th round of inference are similar to the second round of inference. In each round of inference, the inference is performed simultaneously on a batch of input data for which the token inference has proceeded s steps in the previous round of inference and a batch of brand new input data for which the inference is entirely not performed. The entire inference process on the batch of input data for which the token inference has proceeded s steps is completed in this round of inference. The token inference for the other batch of input data for which the inference is entirely not performed has proceeded s steps in this round of inference. Moreover, the updated key tensors and the updated value tensors of the other batch of input data are released, the inference results of the s steps of token inference executed on the other batch of input data in this round are stored in the form of token index, and the specific process will not be elaborated.

For the M-th round of inference, since there is no more input data for which the inference is entirely not performed, it is only necessary to complete the inference on the input data Batch_M for which the token inference has proceeded s steps in the (M−1)-th round of inference according to the aforementioned relevant process performed on the Batch_2 in the second round of inference.

In the above embodiment, after excluding the space occupied by the weight parameters of the neural network itself, the remaining portion in the storage space is basically entirely used to place the updated key tensors and the updated value tensors generated by inference, therefore the volume of the storage space is proportional to portion for which the inference is complete as indicated by the shaded or gray box portions in the figure. As may be seen from FIG. 3, excluding the first round of inference and the M-th round of inference, portions for which the inference is complete in other rounds of inference account for the most substantial part.

For example, taking the second round of inference as an example, for a batch of input data that needs to output a total length of L, when the inference has proceeded to the S-th step of the prompt inference on the input data Batch_3, the entire storage space is used up at this time, which is consistent with the maximum storage space size occupied by a batch of input data for which the inference has proceeded to L steps in a normal state. Therefore 3S+2P=L, that is, the size of S is determined by the formula S=(L−2P)/3.

It should be noted that, in the above embodiment, the specific execution process of the data processing method provided by at least one embodiment of the present disclosure is described with X=2 as an example, but for the case where X takes a larger value, the execution logic is similar, which will not be elaborated here.

In this embodiment, the batch size in the early stage of inference is increased to 2 times, that is, 2*N1 input data elements are subjected to the inference simultaneously. For systems with redundant computing power, the computing power utilization rate may be improved in this part of inference, the utilization rate of tensors cores may be improved, and s steps of inference are additionally executed in each round of inference, thereby improving the overall inference efficiency. In the later stage of inference, the batch size is reduced to N1 to be able to complete the entire inference process on a batch of input data, thereby accelerating the inference.

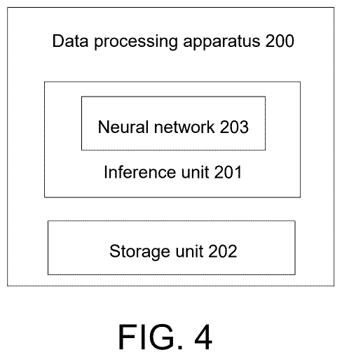

At least one embodiment of the present disclosure also provides a data processing apparatus. FIG. 4 is a schematic block diagram of a data processing apparatus provided by at least one embodiment of the present disclosure.

As shown in FIG. 4, the data processing apparatus 200 may include an inference unit 201 and a storage unit 202. It should be noted that the components and structure of the data processing apparatus 200 shown in FIG. 4 are only exemplary and not restrictive, and according to requirements, the data processing apparatus 200 may also have other components and structures.

For example, these modules may be implemented through hardware (e.g., circuit) modules, software modules, or any combination thereof, and the following embodiments are the same and will not be elaborated. For example, these units may be implemented through a central processing unit (CPU), a graphics processing unit (GPU), a tensor processing unit (TPU), a field-programmable gate array (FPGA), or other forms of processing units having data processing capability and/or instruction execution capability, along with corresponding computer instructions.

For example, the data processing apparatus may be a processor that needs to perform inference operations, for example, the data processing apparatus may be a general-purpose processor such as a central processing unit, a multi-core processor, a graphics processing unit, a general-purpose graphics processing unit, a digital signal processor, or a special-purpose processor such as an AI processor, a tensor processing unit (TPU), a field-programmable gate array (FPGA). For example, the data processing apparatus may be components specifically provided for optimizing computation in some GPUs and AI accelerators, such as deep learning accelerators. Of course, the present disclosure is not limited thereto, and the data processing apparatus may be any device that needs to execute a data processing method for performing corresponding inference operations.

For example, the inference unit 201 is configured to perform an inference operation on data to be processed through a neural network.

For example, the inference operation includes: using the neural network to perform M rounds of inference successively on the data to be processed, wherein the data to be processed includes multiple batches of input data, each batch of the input data includes N1 input data elements, and the entire inference process is completed on only one batch of the input data in each round of inference, and M and N1 are positive integers greater than 1.

For example, the M rounds of inference include an i-th round of inference and an (i+1)-th round of inference executed successively in order, i is a positive integer and less than M.

For example, the inference process of the i-th round of inference includes: at a first stage of the inference process of the i-th round of inference, performing inference on N2 input data elements, at a second stage of the inference process of the i-th round of inference, performing inference on N1 input data elements to complete the entire inference process on the N1 input data elements belonging to the same batch of input data; wherein the first stage is earlier than the second stage, N2 is greater than N1, and the N1 input data elements belonging to the same batch of the input data are a subset of the N2 input data elements.

For example, the inference process of the (i+1)-th round of inference includes: for N2-N1 input data elements for which the inference is incomplete in the i-th round of inference but for which output tokens have been acquired through the inference, performing inference on the N2-N1 input data elements while taking into account the output tokens.

For example, the inference unit 201 includes a neural network 203, and the neural network 203 includes a first sub-network and a second sub-network.

The first sub-network is configured to receive input data elements and extract semantic features corresponding to the input data elements in conjunction with a self-attention mechanism, wherein the semantic features include initial key tensors and initial value tensors.

The second sub-network is configured to predict output token sequences corresponding to the input data elements one by one based on the semantic features in conjunction with an autoregressive mechanism.

For example, in the process of predicting the output token sequences corresponding to the input data elements one by one in conjunction with the autoregressive mechanism, the initial key tensors and the initial value tensors are continuously updated according to already predicted output tokens to obtain updated key tensors and updated value tensors, and lengths of the updated key tensors and the updated value tensors are in a positive proportional relationship with the number of output tokens corresponding to the input data elements that have been predicted.

It should be noted that the neural network 203 in the inference unit 201 has the same structure and function as the neural network 100 in the embodiment of the above data processing method, and will not be elaborated here.

For example, the storage unit 202 is configured to store weight parameters of the neural network and the updated key tensors and the updated value tensors generated during the inference operation. For example, the storage unit 202 may be implemented in forms such as memory, such as HBM (High Bandwidth Memory), etc., and the present disclosure does not specifically limit the specific form of the storage unit.

For example, the inference unit 201 may include a code and programs stored in the memory. A processor may execute the code and the programs to implement some or all functions of the inference unit 201 as described above. For example, the inference unit 201 may be a dedicated hardware device for implementing some or all functions of the inference unit 201 as described above. For example, the inference unit 201 may be a circuit board or a combination of multiple circuit boards for implementing the functions as described above. In embodiments of the present disclosure, the one circuit board or combination of multiple circuit boards may include: (1) one or more processors; (2) one or more non-transitory memories connected to the processor; and (3) firmware executable by the processor and stored in the memory.

It should be noted that the inference unit 201 may be used to implement steps S10 to S30 shown in FIG. 1. Therefore, specific descriptions of functions that the inference unit 201 can implement may refer to relevant descriptions of step S10 to step S30 in the embodiments of the above data processing method, and repetitions will not be elaborated.

The data processing apparatus provided by at least one embodiment of the present disclosure adopts a larger batch size (performing inference on more input data elements simultaneously) in the stage (i.e., the first stage) where the number of inference steps is small and the key tensors and value tensors occupy less storage space to improve computational efficiency and fully utilize the computational power of operators in the processor. As inference continues (i.e., the second stage), the key tensors and the value tensors gradually occupy more storage space, and the batch size is reduced to complete the inference, thereby accelerating the overall inference process, thus fully utilizing system computational power, and improving inference efficiency and computational power utilization. The data processing apparatus 200 may achieve similar technical effects as the aforementioned data processing method, and will not be elaborated here.

It should be noted that, in embodiments of the present disclosure, the data processing apparatus 200 may include more or fewer circuits or units, and the connection relationships between the circuits or units are not limited and may be determined according to actual requirements. The specific configuration of each circuit or unit is not limited and may be constituted by analog devices according to circuit principles, or may be constituted by digital chips, or constituted in other applicable ways.

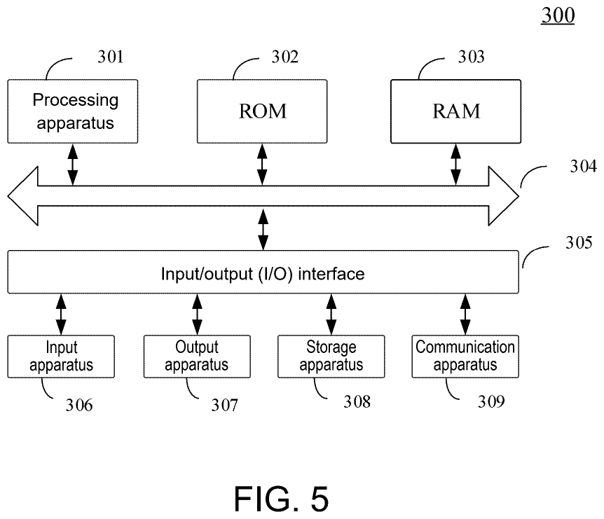

FIG. 5 is a schematic block diagram of an electronic device provided by an embodiment of the present disclosure. As shown in FIG. 5, the electronic device 300 is, for example, suitable for implementing the data processing method provided by embodiments of the present disclosure. It should be noted that the components of the electronic device 300 shown in FIG. 5 are merely exemplary and not restrictive, and according to actual application requirements, the electronic device 300 may also have other components.

As shown in FIG. 5, the electronic device 300 may include a processing apparatus (such as a central processing unit, a graphics processing unit, etc.) 301, which may execute various appropriate actions and processing according to non-transitory computer-readable instructions stored in the memory to implement various functions.

For example, when the computer-readable instructions are executed by the processing apparatus 301, one or more steps in the data processing method according to any of the above embodiments may be executed. It should be noted that detailed descriptions of the processing process of the data processing method may refer to relevant descriptions in the embodiments of the above data processing method, and repetitions will not be elaborated.

For example, the memory may include one or any combination of more computer program products, and the computer program products may include various forms of computer-readable storage media, such as volatile memory and/or non-volatile memory. The volatile memory may include, for example, random access memory (RAM) 303 and/or cache memory, for example, the computer-readable instructions may be loaded from a storage apparatus 308 into the random access memory (RAM) 303 to execute the computer-readable instructions. The non-volatile memory may include, for example, a read-only memory (ROM) 302, a hard disk, an erasable programmable read-only memory (EPROM), a portable compact disk read-only memory (CD-ROM), a USB memory, a flash memory, etc. Various application programs and various data may also be stored in the computer-readable storage medium, such as style images, and various data used and/or generated by application programs.

For example, the processing apparatus 301, the ROM 302, and the RAM 303 are connected to each other through a bus 304. An input/output (I/O) interface 305 is also connected to the bus 304.

Generally, the following apparatuses may be connected to the I/O interface 305: an input apparatus 306 including, for example, a touch screen, a touchpad, a keyboard, a mouse, a camera, a microphone, an accelerometer, a gyroscope, etc.; an output apparatus 307 including, for example, a liquid crystal display (LCD), a speaker, a vibrator, etc.; a storage apparatus 308 including, for example, a magnetic tape, a hard disk, a flash memory, etc.; and a communication apparatus 309. The communication apparatus 309 may allow the electronic device 300 to perform wireless or wired communication with other electronic devices to exchange data. Although FIG. 9 shows the electronic device 300 having various apparatuses, it should be understood that it is not required to implement or have all the apparatuses shown, and the electronic device 300 may alternatively implement or have more or fewer apparatuses. For example, the processor 301 may control other components in the electronic device 300 to execute desired functions. The processor 301 may be a device having data processing capability and/or program execution capability, such as a central processing unit (CPU), a tensor processing unit (TPU), or a graphics processing unit (GPU). The central processing unit (CPU) may be of X86 or ARM architecture, etc. The GPU may be separately and directly integrated on a motherboard, or built into a northbridge chip of the motherboard. The GPU may also be built into the central processing unit (CPU).

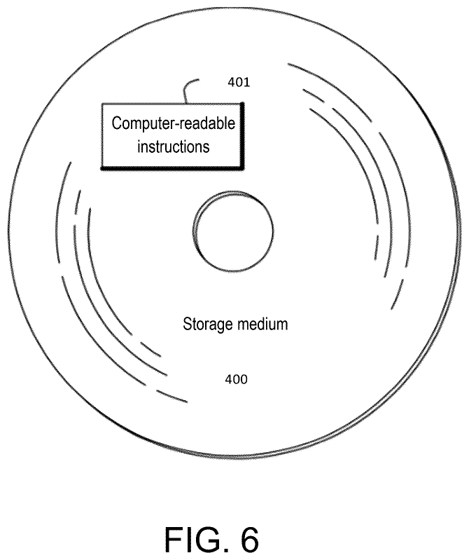

FIG. 6 is a schematic view of a non-transitory computer-readable storage medium provided by at least one embodiment of the present disclosure. For example, as shown in FIG. 6, a storage medium 400 may be a non-transitory computer-readable storage medium, and one or more computer-readable instructions 401 may be non-transitorily stored in the storage medium 400. For example, when the computer-readable instructions 401 are executed by a processor, the data processing method according to the above description may be executed.

For example, the storage medium 400 may be applied to the above electronic device, for example, the storage medium 400 may include a memory in the electronic device.

For example, the storage medium may include a storage card of a smart phone, a storage component of a tablet computer, a hard disk of a personal computer, a random access memory (RAM), a read-only memory (ROM), an erasable programmable read-only memory (EPROM), a portable compact disk read-only memory (CD-ROM), a flash memory, or any combination of the above storage media, and may also be other suitable storage media.

For example, the description of the storage medium 400 may refer to the description of the memory in the embodiment of the electronic device, and repetitive parts will not be elaborated again.

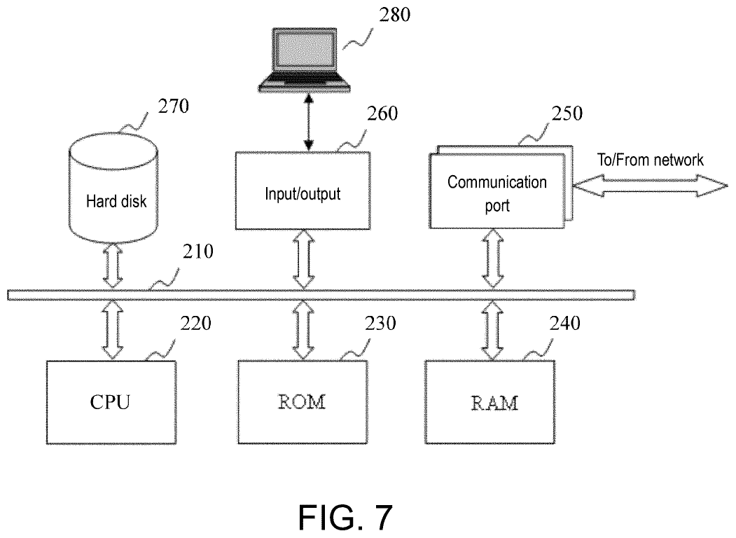

FIG. 7 is a schematic view of a hardware environment provided by at least one embodiment of the present disclosure. The electronic device provided by the present disclosure may be applied in an Internet system.

A computer system provided in FIG. 7 may implement the functions of the data processing apparatus and/or electronic device involved in the present disclosure. Such computer systems may include personal computers, laptop computers, tablet computers, mobile phones, personal digital assistants, smart glasses, smart watches, smart rings, smart helmets, and any smart portable devices or wearable devices. The specific system in this embodiment uses functional block diagrams to explain a hardware platform including a user interface. Such computer device may be a general-purpose computer device or a specific-purpose computer device. Both types of computer devices may be used to implement the data processing apparatus and/or electronic device in this embodiment. The computer system may include any components that implement the information required for implementing data processing as currently described. For example, the computer system may be implemented by computer devices through their hardware devices, software programs, firmware, and combinations thereof. For convenience, only one computer device is shown in FIG. 7, but the relevant computer functions for implementing the information required for data processing described in this embodiment may be implemented in a distributed manner by a group of similar platforms, thus distributing the processing load of the computer

As shown in FIG. 7, the computer system may include a communication port 250, connected to which is a network that implements data communication. For example, the computer system may send and receive information and data through the communication port 250, that is, the communication port 250 may implement wireless or wired communication between the computer system and other electronic devices to exchange data. The computer system may also include a processor group 220 (i.e., the processor described above) for executing program instructions. The processor group 220 may be composed of at least one processor (e.g., CPU). The computer system may include an internal communication bus 210. The computer system may include different forms of program storage units and data storage units (i.e., the memory or storage medium described above), such as the hard disk 270, the read-only memory (ROM) 230, the random access memory (RAM) 240, which may be used to store various data files for computer processing and/or communication, as well as possible program instructions executed by the processor group 220. The computer system may also include an input/output component 260, which is used to implement input/output data flow between the computer system and other components (e.g., user interface 280, etc.).

Generally, the following apparatuses may be connected to the input/output component 260: input apparatuses such as touch screens, touch pads, keyboards, mice, cameras, microphones, accelerometers, gyroscopes, etc.; output apparatuses such as displays (e.g., LCD, OLED displays, etc.), speakers, vibrators, etc.; storage apparatuses including, for example, magnetic tapes, hard disks, etc.; and communication interfaces.

Although FIG. 7 shows a computer system with various apparatuses, it should be understood that the computer system is not required to have all the apparatuses shown, alternatively, the computer system may have more or fewer apparatuses.

Those skilled in the art can understand that the content disclosed in the present disclosure may have various variations and improvements. For example, the various devices or components described above may be implemented through hardware, or through software, firmware, or a combination of some or all of the three.

Furthermore, although the present disclosure makes various references to some units in the system according to embodiments of the present disclosure, any number of different units may be used and run on the client and/or server. The units are merely illustrative, and different aspects of the system and method may use different units.

Flowcharts are used in the present disclosure to illustrate the steps of methods according to embodiments of the present disclosure. It should be understood that the preceding or following steps are not necessarily performed precisely in order. Instead, various steps may be processed in reverse order or simultaneously. Meanwhile, other operations may also be added to these processes.

Those of ordinary skill in the art can understand that all or part of the steps in the above methods may be completed by instructing relevant hardware through computer programs, and the programs may be stored in computer-readable storage media, such as read-only memories, magnetic disks, or optical disks, etc. Alternatively, all or part of the steps of the above embodiments may also be implemented using one or more integrated circuits. Correspondingly, each module/unit in the above embodiments may be implemented in the form of hardware, or may be implemented in the form of software functional modules. The present disclosure is not limited to any specific combination of hardware and software.

Unless otherwise defined, all terms used herein have the same meaning as commonly understood by those of ordinary skill in the art to which the present disclosure belongs. It should also be understood that terms such as those defined in commonly used dictionaries should be interpreted as having meanings consistent with their meanings in the context of the relevant technology, and should not be interpreted with idealized or extremely formalized meanings, unless explicitly defined as such herein.

The above is a description of the present disclosure and should not be considered as limitations thereof. Although several exemplary embodiments of the present disclosure have been described, those skilled in the art will readily understand that many modifications may be made to the exemplary embodiments without departing from the novel teachings and advantages of the present disclosure. Therefore, all such modifications are intended to be included within the scope of the present disclosure as defined by the claims. It should be understood that the above is a description of the present disclosure and should not be considered as limited to the specific embodiments disclosed, and modifications to the disclosed embodiments as well as other embodiments are intended to be included within the scope of the appended claims. The present disclosure is defined by the claims and their equivalents.

1. A data processing method, comprising:
performing an inference operation on data to be processed through a neural network, the inference operation comprising:
using the neural network to perform M rounds of inference successively on the data to be processed, wherein the data to be processed comprises a plurality of batches of input data, each batch of the input data comprises N1 input data elements, and an entire inference process is completed on only one batch of the input data in each round of the inference, and M and N1 are positive integers greater than 1;
the M rounds of inference comprise an i-th round of inference and an (i+1)-th round of inference executed successively in order, i is a positive integer and less than M,
wherein an inference process of the i-th round of inference comprises:
at a first stage of the inference process of the i-th round of inference, performing inference on N2 input data elements,
at a second stage of the inference process of the i-th round of inference, performing inference on N1 input data elements to complete the entire inference process on the N1 input data elements belonging to a same batch of the input data;
wherein the first stage is earlier than the second stage, N2 is greater than N1, and the N1 input data elements belonging to the same batch of the input data are a subset of the N2 input data elements;
an inference process of the (i+1)-th round of inference comprises:
for N2-N1 input data elements for which the inference is incomplete in the i-th round of inference but for which output tokens have been acquired through the inference, performing inference on the N2-N1 input data elements while taking into account the output tokens.

2. The data processing method according to claim 1, wherein the neural network comprises a first sub-network and a second sub-network,
the first sub-network is configured to receive the input data elements and extract semantic features corresponding to the input data elements in conjunction with a self-attention mechanism, wherein the semantic features comprise initial key tensors and initial value tensors,
the second sub-network is configured to predict output token sequences corresponding to the input data elements one by one based on the semantic features in conjunction with an autoregressive mechanism,
in the process of predicting the output token sequences corresponding to the input data elements one by one in conjunction with the autoregressive mechanism, the initial key tensors and the initial value tensors are continuously updated according to predicted output tokens to obtain updated key tensors and updated value tensors, and lengths of the updated key tensors and the updated value tensors are in a positive proportional relationship with a number of output tokens corresponding to the input data elements that have been predicted.

3. The data processing method according to claim 2, wherein N1 is determined by a number of tokens of a longest output token sequence supported by the neural network, a maximum length of the input data elements supported by the neural network, and a size of a storage space used to store the updated key tensors and the updated value tensors.

4. The data processing method according to claim 3, wherein at the first stage of the inference process of the i-th round of inference, performing inference on the N2 input data elements comprises:
determining X batches of input data as the N2 input data elements, wherein the X batches of input data comprise a first batch of input data, the first batch of input data comprises the N1 input data elements for which the entire inference process is complete in the i-th round of inference, X is a positive integer greater than 1;
performing inference on the X batches of input data simultaneously in units of batches.

5. The data processing method according to claim 4, wherein determining the X batches of input data as the N2 input data elements comprises:
in response to i being equal to 1, determining X batches of input data for which the inference is entirely not performed as the X batches of input data;
in response to i being greater than 1:
determining X−1 batches of input data for which the inference is incomplete in an (i−1)-th round of inference, together with one batch of input data for which the inference is entirely not performed, as the X batches of input data, wherein the first batch of input data is determined from the X−1 batches of input data for which the inference is incomplete in the (i−1)-th round of inference.

6. The data processing method according to claim 5, wherein the X−1 batches of input data other than the first batch of input data among the X batches of input data have respective corresponding inference suspension thresholds,
performing inference on the X batches of input data simultaneously in units of batches comprising:
performing inference on the X batches of input data simultaneously, wherein for any batch of input data among the X−1 batches of input data, when the number of output tokens that have been acquired through the inference for the any batch of input data reaches the corresponding inference suspension threshold, suspending the inference on the any batch of input data.

7. The data processing method according to claim 6, wherein,
in response to X=2, the inference suspension threshold is (L−2P)/3, wherein P is a maximum length of input text corresponding to one batch of input data supported by the neural network, L is a sum of a number of tokens of the longest output token sequence supported by the neural network and P, and “/” represents division.

8. The data processing method according to claim 6, wherein when the number of output tokens that have been acquired through the inference for the any batch of input data reaches the corresponding inference suspension threshold, suspending the inference on the any batch of input data comprises:
suspending the inference on the any batch of input data;
storing the output tokens that have been acquired through the inference for the any batch of input data;
clearing the updated key tensors and the updated value tensors generated by the any batch of input data in the i-th round of inference.

9. The data processing method according to claim 8, wherein storing the output tokens that have been acquired through the inference for the any batch of input data comprises:
converting each output token among the output tokens that have been acquired through the inference for the any batch of input data to a corresponding token index;
storing token indices respectively corresponding to the output tokens that have been acquired through the inference for the any batch of input data.

10. The data processing method according to claim 6, wherein performing inference on the X batches of input data simultaneously comprises:
in response to i being greater than 1, for other X−1 batches of input data among the X batches of input data except one batch of input data for which the inference is entirely not performed:
for the N2-N1 input data elements for which the inference is incomplete in the i-th round of inference but for which the output tokens have been acquired through the inference, performing inference on the other X−1 batches of input data while taking into account the output tokens.

11. The data processing method according to claim wherein at the second stage of the inference process of the i-th round of inference, performing inference on the N1 input data elements to complete the entire inference process on the N1 input data elements belonging to the same batch of input data comprises:
performing inference continuously on the first batch of input data until completing the inference on all input data elements in the first batch of input data, wherein the first batch of input data comprises the N1 input data elements for which the entire inference process is complete in the i-th round of inference.

12. The data processing method according to claim 3, wherein for the N2-N1 input data elements for which the inference is incomplete in the i-th round of inference but for which the output tokens have been acquired through the inference, performing inference on the N2-N1 input data elements while taking into account the output tokens comprises:
obtaining the output tokens that have been acquired through the inference for the N2-N1 input data elements in the i-th round of inference, wherein the output tokens that have been acquired through the inference for the N2-N1 input data elements are stored in the storage space in a form of token index;
performing inference on the N2-N1 input data elements in units of batches, wherein for each input data element among the N2-N1 input data elements, the obtained output tokens that have been acquired through the inference for the input data elements and the input data elements are input together into the neural network for inference.

13. The data processing method according to claim 12, wherein inputting the obtained output tokens that have been acquired through the inference for the input data elements and the input data elements together into the neural network for inference comprises:
concatenating token indices corresponding to the output tokens that have been acquired through the inference for the input data elements and token indices corresponding to the input data elements, and inputting a concatenation result into the neural network for inference.

14. The data processing method according to claim 12, wherein the neural network comprises a first sub-network for performing prompt inference and a second sub-network for performing token inference,
while performing the prompt inference on the N2-N1 input data elements through the first sub-network, the prompt inference is performed on one batch of input data for which the inference is entirely not performed through the first sub-network, and
after the prompt inference is complete for both the N2-N1 input data elements and one batch of input data for which the inference is entirely not performed, the token inference is simultaneously initiated on the N2-N1 input data elements and the one batch of input data for which the inference is entirely not performed through the second sub-network.

15. The data processing method according to claim 1, wherein N2 is an integer multiple of N1.

16. A data processing apparatus, comprising:
an inference unit, configured to perform an inference operation on data to be processed through a neural network,
wherein the inference operation comprises:
using the neural network to perform M rounds of inference successively on the data to be processed, wherein the data to be processed comprises a plurality of batches of input data, each batch of the input data comprises N1 input data elements, and an entire inference process is completed on only one batch of the input data in each round of the inference, and M and N1 are positive integers greater than 1;
the M rounds of inference comprise an i-th round of inference and an (i+1)-th round of inference executed successively in order, i is a positive integer and less than M,
wherein an inference process of the i-th round of inference comprises:
at a first stage of the inference process of the i-th round of inference, performing inference on N2 input data elements,
at a second stage of the inference process of the i-th round of inference, performing inference on N1 input data elements to complete the entire inference process on the N1 input data elements belonging to a same batch of the input data;
wherein the first stage is earlier than the second stage, N2 is greater than N1, and the N1 input data elements belonging to the same batch of the input data are a subset of the N2 input data elements;
an inference process of the (i+1)-th round of inference comprises:
for N2-N1 input data elements for which the inference is incomplete in the i-th round of inference but for which output tokens have been acquired through the inference, performing inference on the N2-N1 input data elements while taking into account the output tokens.

17. The data processing apparatus according to claim 16, further comprising a storage unit, wherein the storage unit is configured to store weight parameters of the neural network and updated key tensors and updated value tensors generated during the inference operation.

18. An electronic device, comprising:
a memory, non-transiently storing computer-executable instructions;
a processor, configured to run the computer-executable instructions,
wherein the computer-executable instructions, when executed by the processor, implement the data processing method according to claim 1.

19. A non-transitory computer-readable storage medium, wherein the non-transitory computer-readable storage medium stores computer-executable instructions, and the computer-executable instructions, when executed by a processor, implement the data processing method according to claim 1.
